(19) United States
(12) Patent Application Publication
(10) Pub. No.: US 2025/0063010 A1
(43) Pub. Date: Feb. 20, 2025

(54) CHAT CHANNEL/BOT MEDIATING METHOD AND SYSTEM

(71) Applicant: Ruth MARGALIT, Bnei Brak (IL)

(72) Inventor: Ruth MARGALIT, Bnei Brak (IL)

(21) Appl. No.: 18/723,649

(22) PCT Filed: Dec. 22, 2022
(86) PCT No.: PCT/IL2022/051380

§ 371 Date: Jun. 24, 2024

Related U.S. Application Data
(60) Provisional application No. 63/293,413, filed on Dec. 23, 2021.

(51) Int. Cl. H04L 51/214; H04L 45/74; H04L 51/04

(52) U.S. Cl. CPC H04L 51/214; H04L 45/74; H04L 51/04

(57) ABSTRACT

The present invention provides a mediating system for communicating between at least two users of instant messaging platform or between one user and one business bot, implemented by one or more processors operatively coupled to a non-transitory computer readable storage device, which comprise the module of: —At least one designated mediating channel/bot module having at least one designated address configured for communicating with each user through instant massaging platform and. —At least one router configured to exchange communication between the one mediating module and at least second mediating module or second user and identifying destination addresses of users by applying business rules based on the identified destination using the routing/map table wherein the messages are transferred between the users by the at least mediating channel/bot module though the at least one router. Wherein the users communicate only through the mediating system, using the at least one designated address, maintaining users addresses (masked)/private.

### TECHNICAL FIELD

The present invention relates to the field user-chat channel/bot communication and more particularly, managing and mediating user-chat channel/bot communication over instant messaging platform.

### BACKGROUND ART

### Summary of Invention

The present invention discloses a mediating system for communicating between at least two users of instant messaging platform, implemented by one or more processors operatively coupled to a non-transitory computer readable storage device, which comprise the module of:
At least one designated mediating channel/bot module having at least one designated address configured for communicating with each user through instant massaging platform and.
At least one router configured to exchange communication between the one mediating module and at least second mediating module or second user and identifying destination addresses of users by applying business rules based on the identified destination using the routing/map table.
wherein the messages are transferred between the users by the at least mediating channel/bot module though the at least one router

Wherein the users communicate only through the mediating system, using the at least one designated address, maintaining users addresses (masked)/private.

According to some embodiments of the present invention, the mediating channel/bot module further process said communication for identifying destination and context of message.

The present invention discloses a method for mediating between at least two end users of instant messaging platform, implemented by one or more processors operatively coupled to a non-transitory computer readable storage device, on which are stored modules of instruction code that when executed cause the one or more processors to perform said method comprising the steps of:
a. receiving a request message from a first user through the instant messaging platform using a designated instant messaging platform address of mediating entity.
b. processing said request message by first mediating module of the mediating entity, for identifying destination second user or group of users and message metadata.
c. sending message with meta data to a router of the mediating entity.
d. Receiving/Identifying request destination address
e. Forwarding request using instant message to second user, by a second mediating module of the mediating entity.
f. forwarding response to the router by the second mediating module of the mediating entity.
g. Identifying response destination address and sending response
h. Forward response to the first user, using instant message

The present invention discloses a mediating system for communicating between at least two users of instant messaging platform or between one user and one business bot, implemented by one or more processors operatively coupled to a non-transitory computer readable storage device, which comprise the module of:
At least one designated mediating channel/bot module having at least one designated address configured for communicating with each user through instant massaging platform and;
At least one router configured to exchange communication between the one mediating module and at least second mediating module or second user and identifying destination addresses of users by applying business rules based on the identified destination using the routing/map table;
wherein the messages are transferred between the users by the at least mediating channel/bot module though the at least one router

Wherein the users communicate only through the mediating system, using the at least one designated address, maintaining users addresses (masked)/private.

According to some embodiments of the present invention the mediating channel/bot module further process said communication for identifying destination and context of message.

According to some embodiments of the present invention there at least two mediating modules: a first mediating module configured to intermediate between the Instant Chat platform for the user and the router and a first mediating module intermediate between the router and the Instant Chat platform for the second user or the business bot.

According to some embodiments of the present invention at least one designated mediating channel/bot module is configured for processing the request to identify functionality and destination and chatting with the user for receiving required destination information.

According to some embodiments of the present invention response process include analysing context of content, to check if the required information is provides based on request message.

According to some embodiments of the present invention mediating system is further configured to keep chatting with agent/user if necessary until enough information is received.

According to some embodiments of the present invention the response process includes checking quality of response matching to the request details.

According to some embodiments of the present invention mediating systems further configured to save the communication session chat information.

According to some embodiments of the present invention the mediating systems further configured to check content of messages and/or response, to block said messages and/or response based on pre-de-fined rules or generate an alert.

The present invention discloses a method for mediating between at least two end users of instant messaging platform, implemented by one or more processors operatively coupled to a non-transitory computer readable storage device, on which are stored modules of instruction code that when executed cause the one or more processors to perform said method comprising the steps of:
a. receiving a request message from a first user through the instant messaging platform using a designated instant messaging platform address of mediating entity;
b. processing said request message by first mediating module of the mediating entity, for identifying destination second user and message metadata;
c. sending message with meta data to a router of the mediating entity;
d. Receiving/Identifying request destination address
e. Forwarding request using instant message to second user by a second mediating module of the mediating entity;
f. processing response and forwarding response to the router by the second mediating module of the mediating entity;
g. Identifying response destination address and sending response
h. Forward response to the first user, using instant message

According to some embodiments of the present invention the mediating channel/bot module further process said communication for identifying destination and context of message.

According to some embodiments of the present invention the mediating system has at least two mediating modules: a first mediating module configured to intermediate between the Instant Chat platform for the user and the router and a first mediating module intermediate between the router and the Instant Chat platform for the second user or the business bot.

According to some embodiments of the present invention at least one designated mediating channel/bot module is configured for processing the request to identify functionality and destination and chatting with the user for receiving required destination information.

According to some embodiments of the present invention the response process includes analysing context of content, to check if the required information is provides based on request message.

According to some embodiments of the present invention the mediating system is configured to keep chatting with agent/user if necessary until enough information is received.

According to some embodiments of the present invention response process include checking quality of response matching to the request details.

According to some embodiments of the present invention the mediating system is configured to save the communication session chat information.

According to some embodiments of the present invention the mediating system is configured to check content of messages and/or response, to block said messages and/or response based on pre-de-fined rules or generate an alert.

### BRIEF DESCRIPTION OF DRAWINGS

FIG. 1A is a block diagram illustrating the chat mediating between at least one user and one agent systems according to some embodiments of the present invention.

FIG. 1A1 is a block diagram illustrating the chat mediating systems between one user and multiple agents according to some embodiments of the present invention.

FIG. 1A2 is a block diagram illustrating the chat mediating systems between multiple user/agents and multiple user/agents according to some embodiments of the present invention.

FIG. 1B is a block diagram illustrating the chat mediating systems according to some embodiments of the present invention.

FIG. 1C is a block diagram illustrating the chat mediating having single chat channel/bot module systems according to some embodiments of the present invention.

FIG. 2A is an illustration flow chart of establishing communication between two users using two intermediating channels modules according to some embodiments of the preset invention.

FIG. 2A1 is an illustration flow chart of establishing communication between two users single intermediating channels modules according to some embodiments of the preset invention.

FIG. 2B is an illustration flow chart of communication session between two users two intermediating channels modules according to some embodiments of the preset invention.

FIG. 2B1 is an illustration flow chart of communication session between two users single intermediating channels modules according to some embodiments of the preset invention.

FIG. 2C is an illustration flow chart of ending communication session between two users two intermediating channels modules according to some embodiments of the preset invention.

FIG. 2C1 is an illustration flow chart of ending communication session between two users single intermediating channels modules according to some embodiments of the preset invention.

FIG. 3 is an illustration flow chart of the first mediating module (200A) according to some embodiments of the preset invention.

FIG. 4 is an illustration flow chart of the second mediating module (200B) according to some embodiments of the preset invention.

FIG. 5 is an illustration flow the single mediating module (200c) according to some embodiments of the preset invention.

FIG. 6 is an illustration flow chart of the router (300) according to some embodiments of the preset invention

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

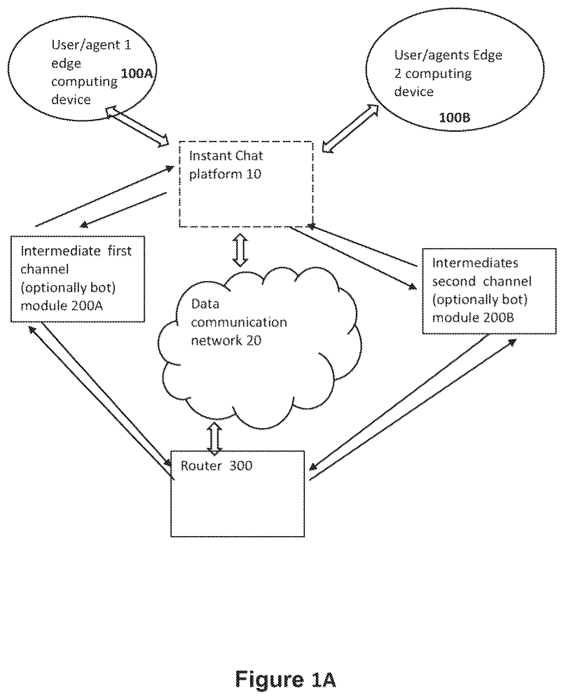

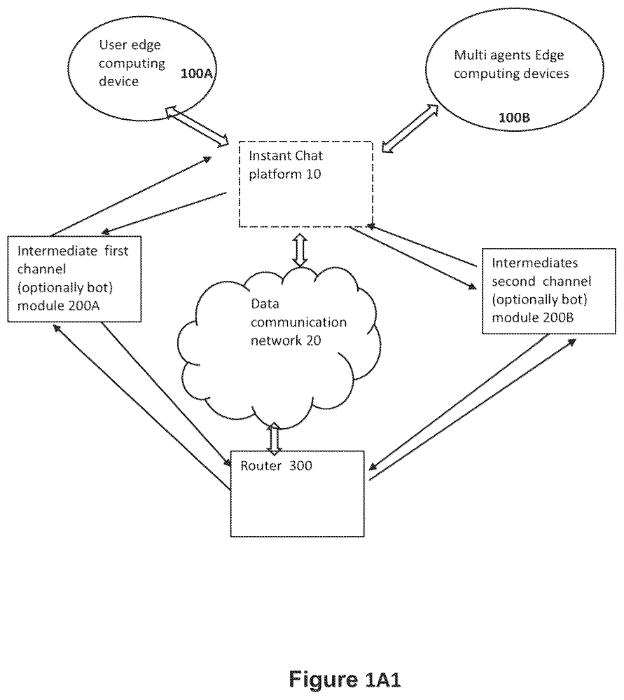

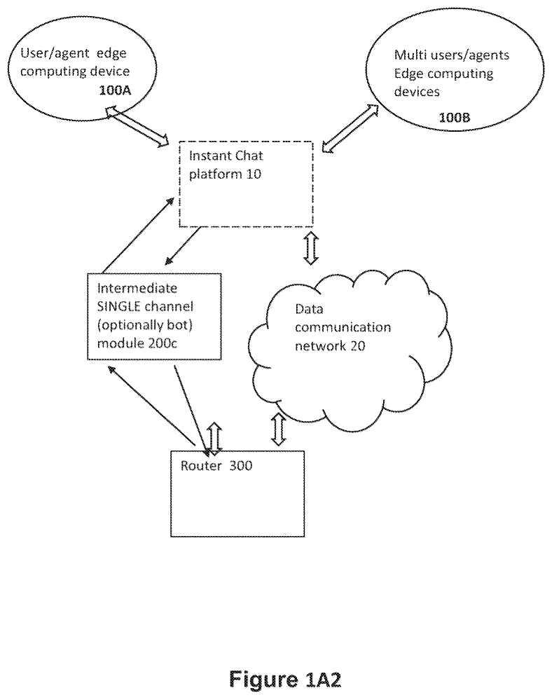

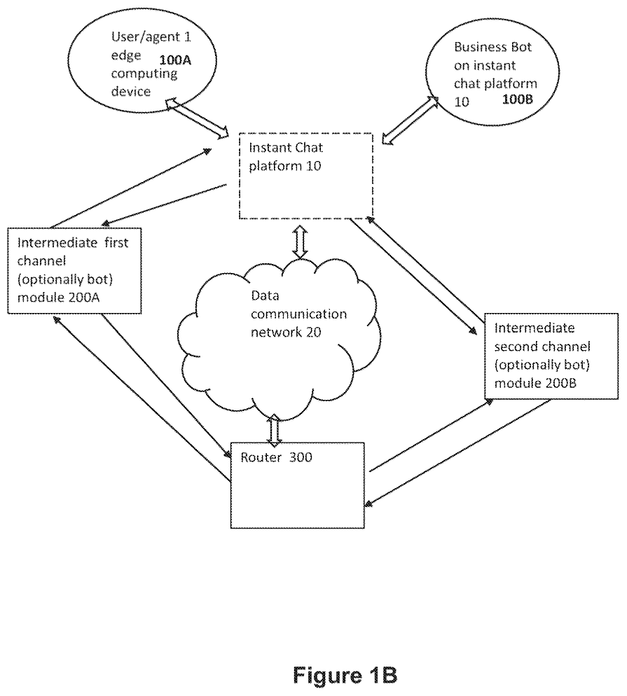

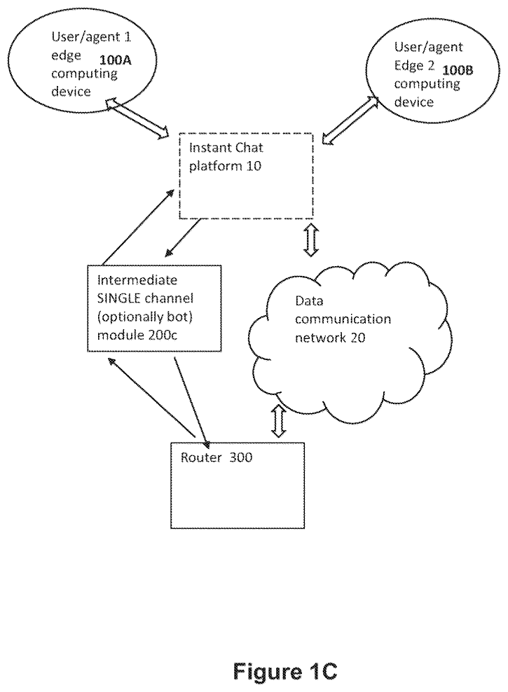

FIG. 1A is a block diagram illustrating the chat mediating systems according to some embodiments of the present invention.

The mediating system as in FIG. 1 is comprised of first and second intermediate chatting bots (200A, 200B), the chatting bots have at least one designated address in the instant messaging platform such as WhatsApp, configured to chat with at least one user/agent (100A, 100B) to identify and understand the destination and optionally context of user/agent request or response. The two mediating channel modules which may be optionally implemented as bots, are communicating through router 300. The router is configured identify/restore relevant address of a second user based on the first user request, which is received from the first mediating module and identified/restore destination of first user address for the returned response.

FIG. 1A1 is a block diagram illustrating the chat mediating systems between one user and multiple agents according to some embodiments of the present invention.

According to this embodiment, the intimidating channels/bot module enable communication between one user and multiple agents group, for instance one user may connect expert group of one or more service provider, enabling to chat with group of experts or assistants

FIG. 1A2 is a block diagram illustrating the chat mediating systems between multiple user/agents according to some embodiments of the present invention.

According to this embodiment, the intimidating channels/bot module enable communication between multiple users agents, for instance multiple agents/members of one or more organization are having group chat through the system router, enabling to monitor the chat and save its content.

In the communication between the user as provided by the intermediating system enabling communication between at least two user while maintaining communication address private (unknown), there are two stages, at the first stage the user has a request for information and service, but he may not have specific of the destination identity or address of the second user/agent which can provide his requested service or information. Optionally the user may have the destination address but prefer to maintain communicate private, not revealing his personal address or just benefit from the help of the intermediating channel/bot. The user sends his request to know designated address of the intermediating system, using an instant massaging platform 10, the request is received and processed at a first mediating channel/chatting bot module for identifying destination user/agent of the request and optionally analysing content and context of the request for better understating the destination and the required response. At this stage the required destination address is identified and recorded by the router in association with the user identify and address and session Id.

At the second stage, both users' addresses are known, and the mediating system enables continuous instant messaging communication between the users. Optionally the mediating channels/bots may continue to analyze the messages, understanding the content and context to improve quality and efficiency of the communication between the two users. At a third stage the conversation session is ended by one of the users or by the system after identifying idle time for predefined period of time.

According to some embodiments of the present invention it is optionally suggested to record all conversation data including both sides identification or addresses. The recordation is saved in compliance with official regulatory requirements.

FIG. 1B is a block diagram illustrating the chat mediating systems according to some embodiments of the present invention.

According to this embodiment the second user is a bot.

FIG. 1C is a block diagram illustrating the chat mediating having single chat channel/bot module systems according to some embodiments of the present invention.

According to this embodiment is used only a single channels/bot chat bot.

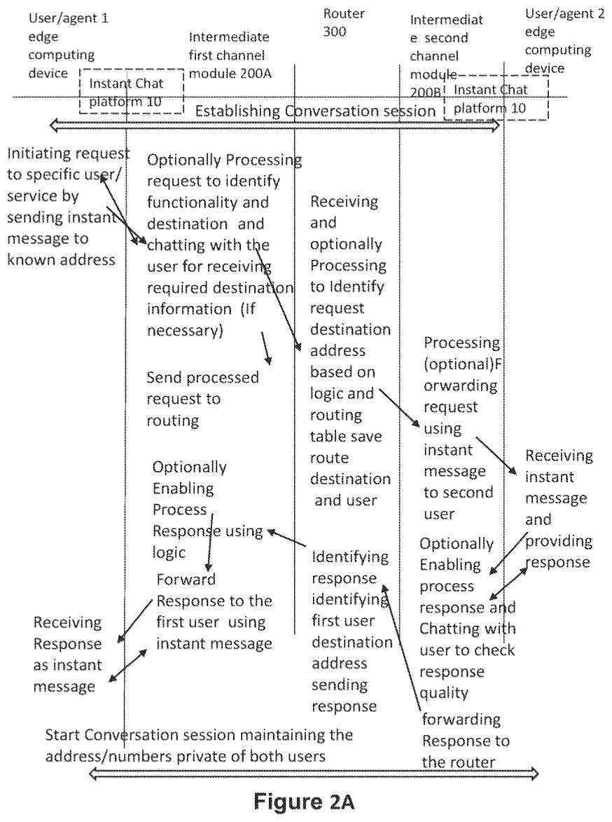

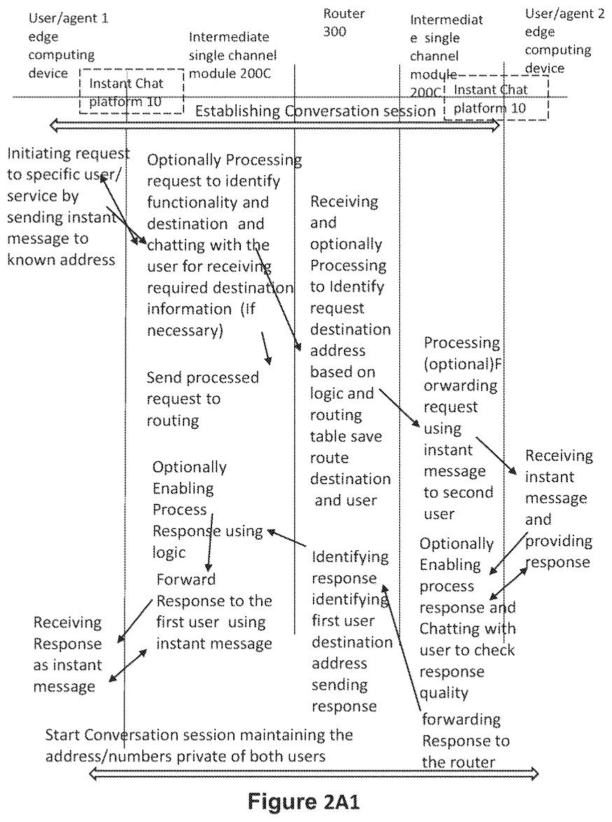

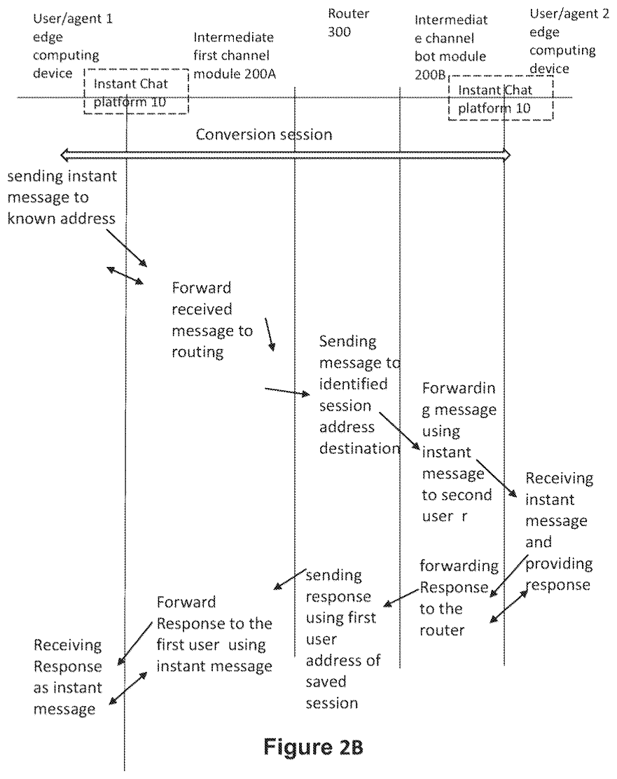

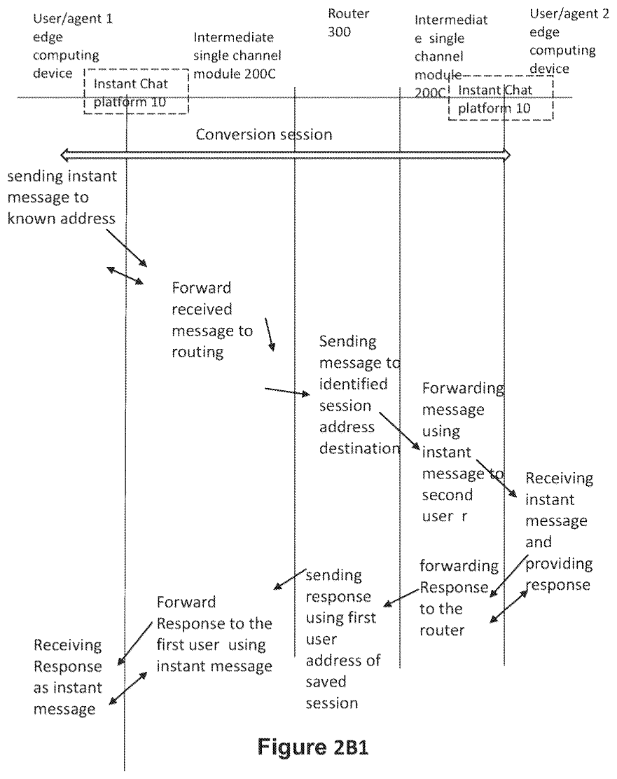

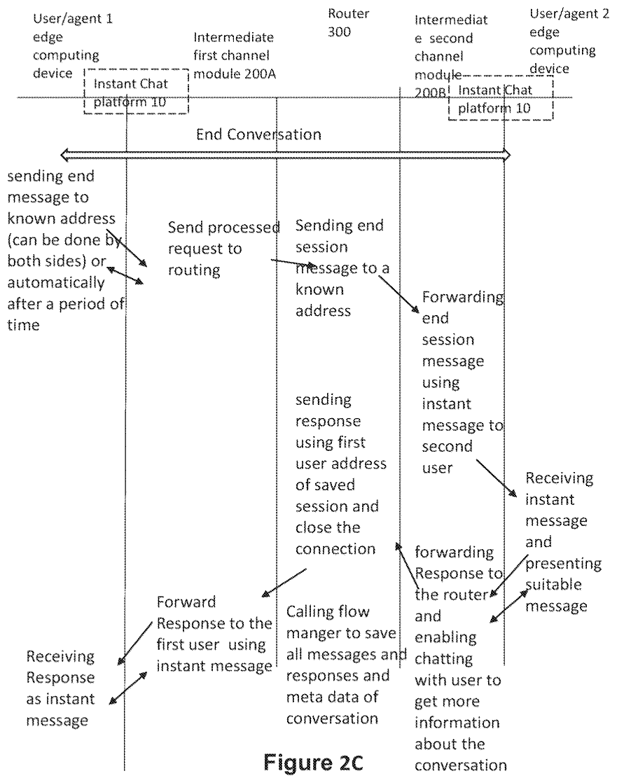

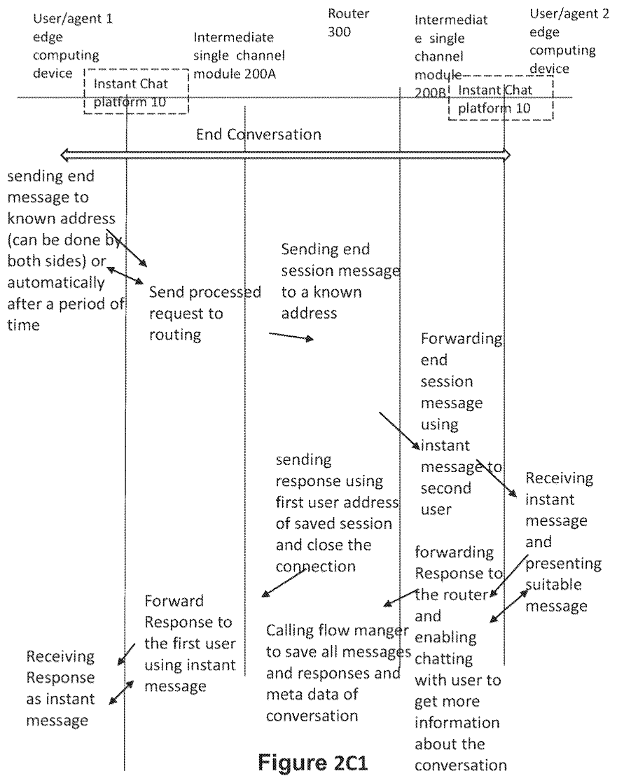

FIG. 2A is an illustration flow chart of establishing communication between two users using two intermediating channels modules according to some embodiments of the preset invention.

This flow describes the process of establishing Conversion session between two users, where the first user doesn't need to know the address of his request destination:

The first user is initiating request to specific user/service by sending instant message to known address of the intermediating system (1010).

The first mediating channel/bot optionally process the request to identify functionality and destination and chatting with the user for acquiring the required information for identifying required destination and/or required information or service (1012).

The first mediating channel/bot sends processed or as is the request to router using a data communication network; (1014)

The router processes the request data to identify destination address based on logic and routing table and save route destination addresses. (1016).

The router forwards request using instant message to second user (1018);

The second user agent, receives instant message and provides response (1020);

The second intermediate channel/bot module optionally process response to understand context and optionally chat with the second user to check if response is responsive to the first user request (checking response quality) and forwarding response to the router; (1022)

The router receives response, identifies first user destination address and sending response to the user through the first mediating chat bot. (1024)

The first mediating chat channel/bot optionally process response using logic and Forward Response to the first user using instant message; (1026);

At the end of the process the first users receive response as instant message and a live communication session is started; (1028)

FIG. 2A1 is an illustration flow chart of establishing communication between two users single intermediating channels modules according to some embodiments of the preset invention.

This flow describes the process of establishing Conversion session between two users, where the first user doesn't need to know the address of his request destination:

The first user is initiating request to specific user/service by sending instant message to known address of the intermediating system (1010);

The single channel/mediating bot optionally process the request to identify functionality and destination and chatting with the user for acquiring the required information for identifying required destination and/or required information or service (1012);

The single channel/mediating bot sends processed or as is the request to router using a data communication network; (1014)

The router processes the request data to identify destination address based on logic and routing table and save route destination addresses. (1016);

The router forwards request using instant message to second user (1018);

The second user agent, receives instant message and provides response (1020);

The single channel/intermediate bot module optionally process response to understand context and optionally chat with the second user to check if response is responsive to the first user request (checking response quality) and forwarding response to the router;(1022)

The router receives response, identifies first user destination address and sending response to the user through the single channel/mediating chat bot. (1024)

The first mediating chat channel/bot optionally process response using logic and Forward Response to the first user using instant message; (1026);

At the end of the process the first users receive response as instant message and a live communication session is started; (1028)

Start Conversion session maintaining the address/numbers private of both users

FIG. 2B is an illustration flow chart of communication session between two users two intermediating channels modules according to some embodiments of the preset invention.

This messaging flow describe the messaging intermediating after the communication session was established and the two user destination addresses are known to intermediating system;

The first users send instant message to known address of the intermediating systems; (1012B), optionally analysing request for accommodating the response content, context to the second user/agent requirements;

The first intermediating channel/bot sends processed request to router (1012B)

The router sends request to saved session identified destination address (1014A);

The second intermediating channel/bot forwarding message using instant message to second user (1016B),

The second user receives the instant message and provides response (1018B);

The second intermediating channel/bot forwarding Response to the router, optionally analysing response and chat with the second user to provide response which is responsive to the user request; (1020B)

The router sends response using first user address of saved session; (1022B)

The first intermediating channel/bot forward Response to the first user using instant message; (1024B)

The first user receiving Response as instant message. (1026B)

FIG. 2B1 is an illustration flow chart of communication session between two users single intermediating channels modules according to some embodiments of the preset invention.

This messaging flow describe the messaging intermediating after the communication session was established and the two user destination addresses are known to intermediating system;

The first users send instant message to known address of the intermediating systems; (1012B), optionally analysing request for accommodating the response content, context to the second user/agent requirements;

The single channel/intermediating/bot sends processed request to router (1012B)

The router sends request to saved session identified destination address (1014A);

The single channel/intermediating channel/bot forwarding message using instant message to second user (1016B),

The second user receives the instant message and provides response (1018B);

The single channel/intermediating chatbot forwarding Response to the router, optionally analysing response and chat with the second user to provide response which is responsive to the user request; (1020B)

The router sends response using first user address of saved session; (1022B)

The first intermediating chatbot forward Response to the first user using instant message; (1024B)

The first user receiving Response as instant message. (1026B)

FIG. 2C is an illustration flow chart of ending communication session between two users two intermediating channels modules according to some embodiments of the preset invention. This messaging flow describe the ending of messaging after the communication session: sending instant message to known address.

The first users send an end message to known address (can be done by both sides) or the systems initiate end message automatically after a predefined period of time; (1012C);

The first intermediating chatting channel/bot module sends processed end request to the router (1014C);

The router sends end session message to a known address (1016C);

The first intermediating chatting channel/bot module forwarding end session message using instant message to second user (1018C)

The second user receives the instant message and presenting suitable message (1020);

The second intermediating charting channel/bot module forwards the response to the router and optionally enabling chatting with user to get more information about the conversation and optionally save it for record purposes (This can be done also by the first intermediating chat bot) (1022);

The router sends response using first user address of saved session and close the connection (1024C);

The first intermediating channel/bot module forwards response to the first user using instant message platform (106C);

According to some embodiments of the present invention the router may call a flow manger to save all messages and/or responses and/or meta data of conversation

FIG. 2C1 is an illustration flow chart of ending communication session between two users single intermediating channels modules according to some embodiments of the preset invention. This messaging flow describe the ending of messaging after the communication session: sending instant message to known address;

The first users send an end message to known address (can be done by both sides) or the systems initiate end message automatically after a predefined period of time; (1012C);

The single channel/intermediating chatting bot module sends processed end request to the router(1014C);

The router sends end session message to a known address (1016C);

The single channel/intermediating chatting bot module forwarding end session message using instant message to second user (1018C)

The second user receives the instant message and presenting suitable message (1020);

The single channel/intermediating charting bot module forwards the response to the router and optionally enabling chatting with user to get more information about the conversation and optionally save it for record purposes (This can be done also by the single channel/intermediating chat bot) (1022);

The router sends response using first user address of saved session and close the connection(1024C);

The first intermediating chatting bot module forwards response to the first user using instant message platform(106C);

Start Conversion session maintaining the address/numbers private of both users

According to some embodiments of the present invention the router may call a flow manger to save all messages and/or responses and/or meta data of conversation.

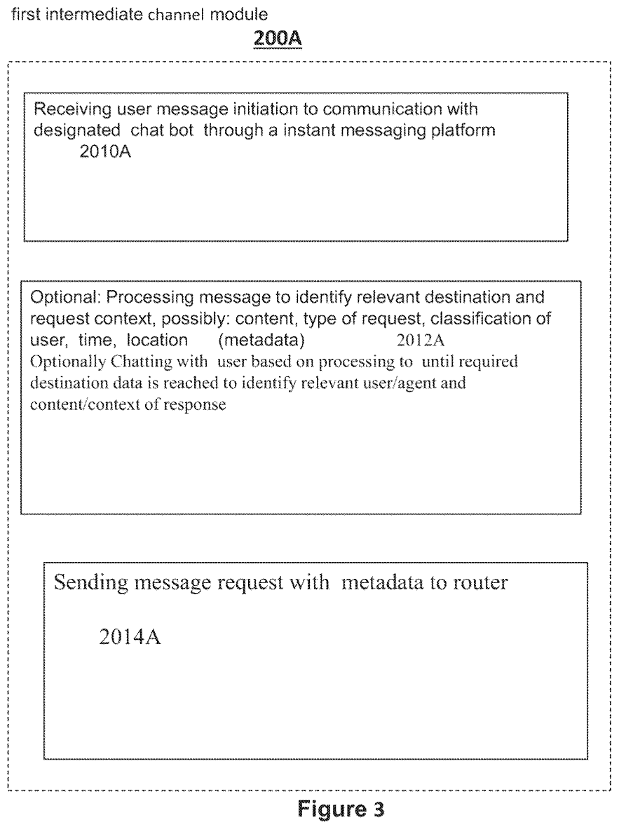

FIG. 3 is an illustration flow chart of the first mediating module (200A) according to some embodiments of the preset invention.

The first mediating module, applies one of the followings steps:

Receiving user message request initiation to communication with designated channel/bot through an instant messaging planform 2010A;

Processing message to identify relevant destination and optionally analyze request context: content, type of request, classification of user, time, location (metadata)2012A;

Chatting with user based on processing to until required destination data is reached to identify relevant agent and sending message request with metadata to router 2014A;

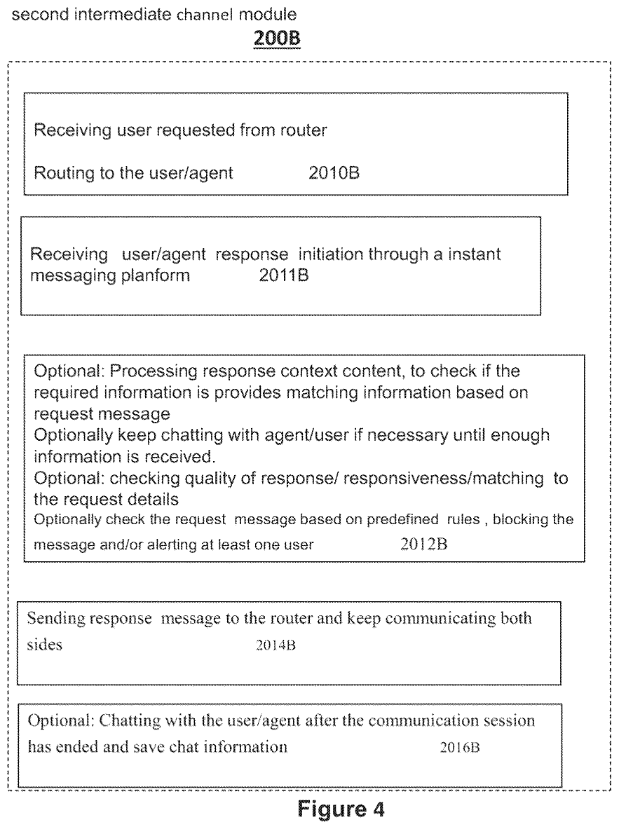

FIG. 4 is an illustration flow chart of the second mediating module (200B) according to some embodiments of the preset invention.

The second mediating module, applies one of the followings steps:
Receiving user request from router (2010B);
Routing request to the user/agent 2012B;
Receiving user/agent response initiation through an instant messaging planform (2014B);
Optionally processing response context: content, to check if the required information is provided based on request message (2016B);
Optionally, chatting with agent until enough information is received no response to the user 2018B;
Sending response message to the router at the ends of chat session 2016B.

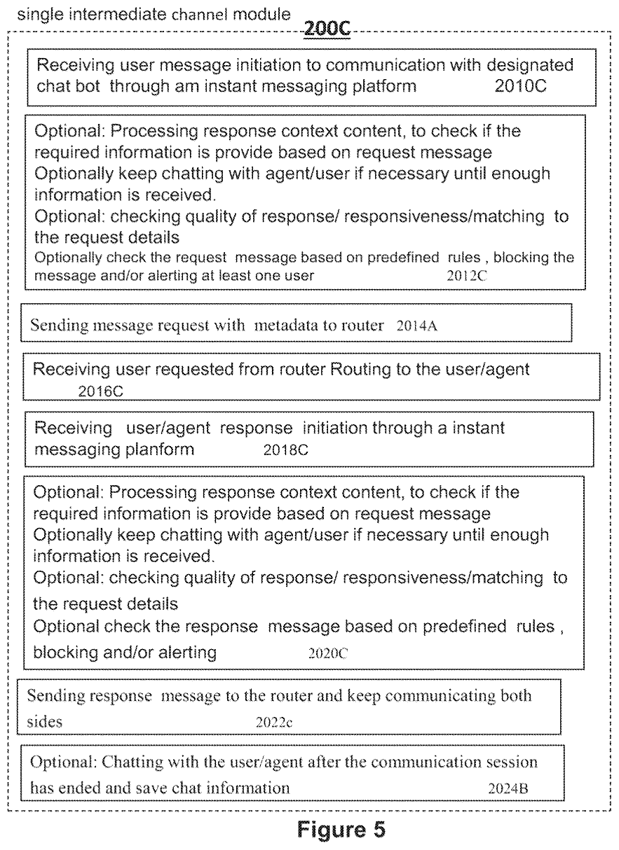

FIG. 5 is an illustration flow the single mediating module (200c) according to some embodiments of the preset invention.

The single mediating module, applies one of the followings steps:
Receiving user message request initiation to communication with designated chat bot through an instant messaging planform 2010C;
Processing message to identify relevant destination and optionally analyze request context: content, type of request, classification of user, time, location (metadata)2012C;
Optional: Processing response context content, to check if the required information is provided based on request message
Optionally keep chatting with agent/user if necessary until enough information is received.
Optional: checking quality of response/responsiveness/matching to the request details
Optionally check the request message based on predefined rules, blocking the message and/or alerting at least one user
Sending message request with metadata to router 2014A
Optionally check the request message based on predefined rules, blocking the message and/or alerting at least one user
Optionally check the request message based on predefined rules, blocking the message and/or alerting at least one user
Chatting with user based on processing to until required destination data is reached to identify relevant agent and sending message request with metadata to router.
Receiving user message request initiation to communication with designated chat bot through an instant messaging planform 2016C;
Processing message to identify relevant destination and optionally analyze request context: content, type of request, classification of user, time, location (metadata)2018C;
Optional: Processing response context content, to check if the required information is provided based on request message
Optionally keep chatting with agent/user if necessary until enough information is received.
Optional: checking quality of response/responsiveness/matching to the request details
Optional check the response message based on predefined rules, blocking and/or alerting
Chatting with user based on processing to until required destination data is reached to identify relevant agent and sending message request with metadata to router 2020C; Optional check the response message based on predefined rules, blocking and/or alerting
Sending response message to the router and keep communicating both sides 2022c;
Optional: Chatting with the user/agent after the communication session has ended and save chat information 2024B;

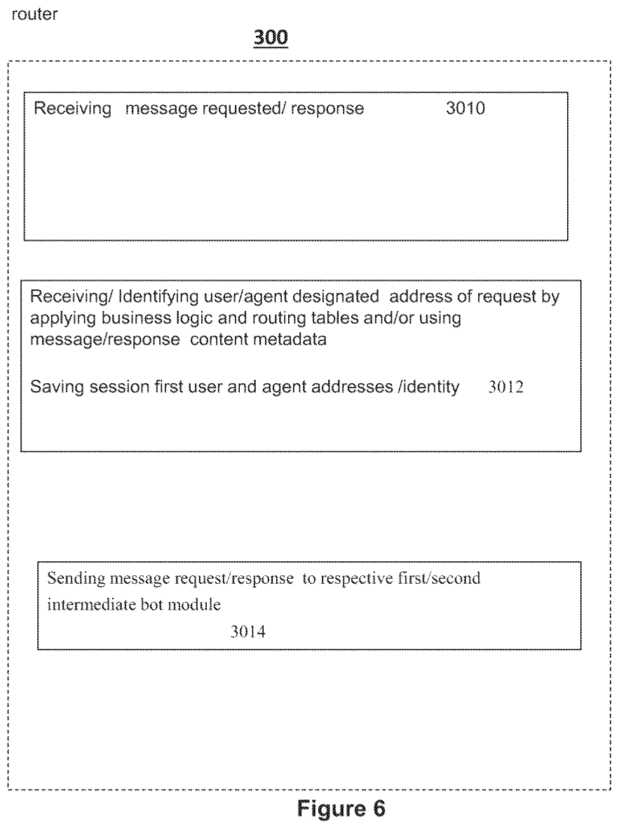

FIG. 6 is an illustration flow chart of router, (300) according to some embodiments of the preset invention. (3012B)
Receiving message requested/response 3010;
Identifying user/agent designated address of request by applying business logic and using routing tables and/or using message/response content metadata and saving session first user and agent addresses/identity 3012;
Sending message request/response to respective first/second intermediate device 3014;

1. A mediating system for communicating between at least two users of instant messaging platform or between one user and one business bot, implemented by one or more processors operatively coupled to a non-transitory computer readable storage device, which comprise the module of:
At least one designated mediating channel/bot module having at least one designated address configured for communicating with each user through instant massaging platform and;
At least one router configured to exchange communication between the one mediating module and at least second mediating module or second user and identifying destination addresses of users by applying business rules based on the identified destination using the routing/map table;
wherein the messages are transferred between the users by the at least mediating channel/bot module though the at least one router
Wherein the users communicate only through the mediating system, using the at least one designated address, maintaining users addresses private.

2. The mediating system of claim 1 wherein the mediating channel/bot module further process said communication for identifying destination and context of message.

3. The mediating system of claim 1 having at least two mediating modules: a first mediating module configured to intermediate between the Instant Chat platform for the user and the router and a first mediating module intermediate between the router and the Instant Chat platform for the second user or the business bot.

4. The mediating system of claim 1 wherein at least one designated mediating channel/bot module is configured for processing the request to identify functionality and destination and chatting with the user for receiving required destination information.

5. The mediating systems of claim 1 wherein response process include analysing context of content, to check if the required information is provides based on request message.

6. The mediating system of claim 1 further at least one designated mediating channel/bot module is configured to keep chatting with agent/user if necessary until enough information is received.

7. The mediating system of claim 1 wherein response process includes checking quality of response matching to the request details.

8. The mediating system of claim 1 wherein at least one designated mediating channel/bot module is further configured to save the communication session chat information.

9. The mediating systems of claim 1 further configured to check content of messages and/or response, to block said messages and/or response based on pre-de-fined rules or generate an alert.

10. A method for mediating between at least two end users of instant messaging platform, implemented by one or more processors operatively coupled to a non-transitory computer readable storage device, on which are stored modules of instruction code that when executed cause the one or more processors to perform said method comprising the steps of:
a. receiving a request message from a first user through the instant messaging platform using a designated instant messaging platform address of mediating entity;
b. processing said request message by first mediating module of the mediating entity, for identifying destination second user and message metadata;
c. sending message with meta data to a router of the mediating entity;
d. Receiving/Identifying request destination address
e. Forwarding request using instant message to second user by a second mediating module of the mediating entity;
f. processing response and forwarding response to the router by the second mediating module of the mediating entity;
g. Identifying response destination address and sending response
h. Forward response to the first user, using instant message

11. The mediating method of claim 10 wherein the mediating channel/bot module further process said communication for identifying destination and context of message.

12. The mediating method of claim 10 having at least two mediating modules: a first mediating module configured to intermediate between the Instant Chat platform for the user and the router and a first mediating module intermediate between the router and the Instant Chat platform for the second user or the business bot.

13. The mediating method of claim 10 wherein at least one designated mediating channel/bot module is configured for processing the request to identify functionality and destination and chatting with the user for receiving required destination information.

14. The mediating method of claim 10 wherein response process includes analysing context of content, to check if the required information is provides based on request message.

15. The mediating method of claim 10 further configured to keep chatting with agent/user if necessary until enough information is received.

16. The mediating method of claim 10 wherein response process includes checking quality of response matching to the request details.

17. The mediating method of claim 10 further configured to save the communication session chat information.

18. The mediating method of claim 10 further configured to check content of messages and/or response, to block said messages and/or response based on pre-de-fined rules or generate an alert.
